(19) United States
(12) Patent Application Publication
(10) Pub. No.: US 2018/0083453 A1
(43) Pub. Date: Mar. 22, 2018

(54) POWER CONVERTING MODULE, POWER GENERATING SYSTEM, AND CONTROL METHOD THEREOF

(71) Applicant: DELTA ELECTRONICS, INC., Taoyuan City (TW)

(72) Inventor: Yu-Ming CHANG, Taoyuan City (TW)

(21) Appl. No.: 15/585,158

(22) Filed: May 2, 2017

(30) Foreign Application Priority Data
Sep. 21, 2016 (TW) 105130421

(51) Int. Cl. H02J 3/38; H02M 3/04; H02M 7/04; H02M 7/44; H02J 7/00

(52) U.S. Cl. CPC H02J 3/385; H02J 3/386; H02M 3/04; H02J 7/0068; H02M 7/44; H02J 3/382; H02M 7/04

(57) ABSTRACT

A power converting module includes a generator-side converting circuit, a grid-side converting circuit, and a controlling and driving circuit. The generator-side converting circuit is configured to receive an input voltage and output a first current according to the input voltage. The grid-side converting circuit is electrically coupled to the generator-side converting circuit at a node, and configured to receive the first current and supply power to a grid according to the first current. The controlling and driving circuit is configured to output a driving signal to the grid-side converting circuit to control a voltage level at the node through the grid-side converting circuit, in which a voltage at the node is within a medium voltage (MV) level.

### RELATED APPLICATIONS

This application claims priority to Taiwan Application Serial Number 105130421, filed Sep. 21, 2016, which is herein incorporated by reference.

### BACKGROUND

### Technical Field

The present disclosure relates to a power generating system. More particularly, the present disclosure relates to a power generating system using renewable energy.

### Description of Related Art

With the intensification of global warming, using renewable energy, such as low-carbon power sources including wind power, solar power, etc., to replace the traditional thermal power generating units with high carbon emissions has become an important goal in promotion of energy transition in various countries.

However, the electric power generated by the current wind turbines and solar power generating modules needs to be processed by power converting circuits correspondingly before being fed into the grids. As the capacity of the power generating equipment increases, the volumes and costs of components required by the power converting circuit are also increased.

For the forgoing reasons, there is a need to improve the structure of the prior art renewable energy power generating system so as to reduce the cost of equipment and increase the power conversion efficiency.

### SUMMARY

One aspect of the present disclosure is a power converting module. The power converting module includes a first generator-side converting circuit, a grid-side converting circuit, and a controlling and driving circuit. The first generator-side converting circuit is configured to receive an input voltage and output a first current according to the input voltage. The grid-side converting circuit is electrically coupled to the first generator-side converting circuit at a node, and configured to receive the first current and supply power to a grid according to the first current. The controlling and driving circuit is configured to output a driving signal to the grid-side converting circuit to control a voltage level at the node through the grid-side converting circuit, wherein a voltage at the node is within a medium voltage level.

Another aspect of the present disclosure is a power generating system. The power generating system includes a power generating module, a power converting module, and a grid-side switching circuit. The power converting module includes a first generator-side converting circuit, a grid-side converting circuit, and a controlling and driving circuit. The first generator-side converting circuit is electrically coupled to the power generating module, and configured to receive an input voltage from the power generating module and output a first current according to the input voltage. The grid-side converting circuit is electrically coupled to the first generator-side converting circuit at a node, and configured to receive the first current and supply power to a grid according to the first current. The controlling and driving circuit is configured to output a driving signal to the grid-side converting circuit to control a voltage level at the node through the grid-side converting circuit. The grid-side switching circuit is electrically coupled between the grid-side converting circuit and the grid, and configured to be selectively turned off so as to isolate the grid-side converting circuit and the grid when the grid is abnormal.

Yet another aspect of the present disclosure is a control method of a power generating system. The control method includes: receiving an input voltage and generating a first current according to the input voltage by a first generator-side converting circuit; outputting a driving signal to a grid-side converting circuit by a controlling and driving circuit, wherein the grid-side converting circuit is coupled to the first generator-side converting circuit at a node; controlling a voltage level at the node according to the driving signal by the grid-side converting circuit; and converting the first current into AC power and outputting the AC power to the grid by the grid-side converting circuit.

It is to be understood that both the foregoing general description and the following detailed description are by examples, and are intended to provide further explanation of the disclosure as claimed.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure. In the drawings,

FIG. 1 depicts a schematic diagram of a power generating system according to some embodiments of the present disclosure;

FIG. 2 depicts a schematic diagram of a power generating system according to some embodiments of the present disclosure;

FIG. 3 depicts a schematic diagram of a power generating system according to some embodiments of the present disclosure;

FIG. 4 depicts a schematic diagram of a power generating system according to some embodiments of the present disclosure;

FIG. 5 depicts a schematic diagram of a power generating system according to some other embodiments of the present disclosure; and

FIG. 6 depicts a flowchart of a control method of a power generating system according to some embodiments of the present disclosure.

### DESCRIPTION OF THE EMBODIMENTS

Reference will now be made in detail to embodiments of the present disclosure, examples of which are described herein and illustrated in the accompanying drawings. While the disclosure will be described in conjunction with embodiments, it will be understood that they are not intended to limit the disclosure to these embodiments. Description of the operation does not intend to limit the operation sequence. Any structures resulting from recombination of devices with equivalent effects are within the scope of the present disclosure. It is noted that, in accordance with the standard practice in the industry, the drawings are only used for understanding and are not drawn to scale. Hence, the drawings are not meant to limit the actual embodiments of the present disclosure. In fact, the dimensions of the various features may be arbitrarily increased or reduced for clarity of discussion. Wherever possible, the same reference numbers are used in the drawings and the description to refer to the same or like parts for better understanding.

The terms used in this specification and claims, unless otherwise stated, generally have their ordinary meanings in the art, within the context of the disclosure, and in the specific context where each term is used. Certain terms that are used to describe the disclosure are discussed below, or elsewhere in the specification, to provide additional guidance to the practitioner skilled in the art regarding the description of the disclosure.

Furthermore, it should be understood that the terms, “comprising”, “including”, “having”, “containing”, “involving” and the like, used herein are open-ended, that is, including but not limited to. It will be understood that, as used herein, the phrase “and/or” includes any and all combinations of one or more of the associated listed items.

In this document, the term “coupled” may also be termed “electrically coupled,” and the term “connected” may be termed “electrically connected.” “Coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments.

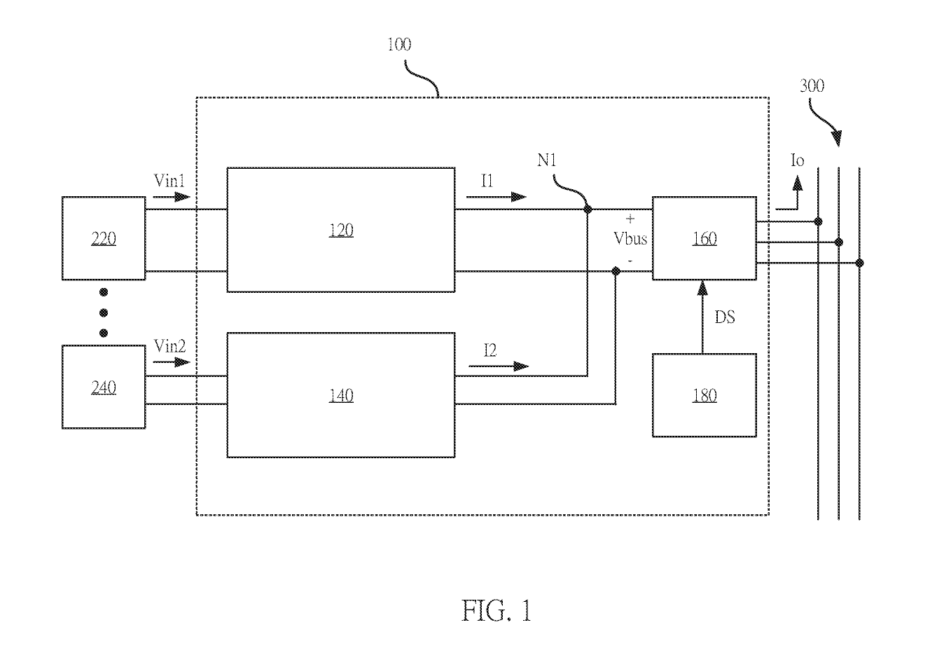

A description is provided with reference to FIG. 1. FIG. 1 depicts a schematic diagram of a power generating system according to some embodiments of the present disclosure. As shown in FIG. 1, in some embodiments, the power generating system includes a power converting module 100, power generating modules 220, 240, and a grid 300. The power converting module 100 is electrically coupled between the power generating modules 220, 240 and the grid 300 and configured to convert electrical energy output from the power generating modules 220, 240 into a form suitable for being fed into the grid 300. In greater detail, an input terminal of the power converting module 100 is electrically coupled to the power generating modules 220, 240 so as to receive input voltages Vin1, Vin2. An output terminal of the power converting module 100 is electrically coupled to the grid 300 so as to supply power to the grid 300 and output a current Io.

In some embodiments, the power converting module 100 includes generator-side converting circuits 120, 140, a grid-side converting circuit 160, and a controlling and driving circuit 180. As for the structure, the generator-side converting circuit 120 is configured to be electrically coupled to the power generating module 220 so as to receive the input voltage Vin1 and output a current I1 according to the input voltage Vin1. Similarly, the generator-side converting circuit 140 is configured to be electrically coupled to the power generating module 240 so as to receive the input voltage Vin2 and output a current I2 according to the input voltage Vin2.

The grid-side converting circuit 160 is electrically coupled to the generator-side converting circuits 120, 140 at a node N1 and configured to receive the currents I1, I2 and output the current Io according to the received currents I1, I2 so as to supply power to the grid 300. In greater detail, in some embodiments, the grid-side converting circuit 160 includes a direct current-alternating current (DC-AC) converting unit to convert the received DC currents I1, I2 into the AC current Io having a same frequency and same phases as the grid 300 and output the AC current Io so as to supply power to the grid 300. In greater detail, in some embodiments, the grid-side converting circuit 160 may be implemented by using one insulated gate bipolar transistor (IGBT) or a plurality of insulated gate bipolar transistors connected in series, or may be implemented by using different circuit structures, such as a 3-level neutral point clamped (NPC) inverter. However, the present disclosure is not limited in this regard.

It is noted that although the two generator-side converting circuits 120, 140 are depicted in the embodiment shown in FIG. 1, they only serve as an example and are not intended to limit the present disclosure. For example, in some embodiments, the power generating system may only include the power generating module 220 and the generator-side converting circuit 120 corresponding to the power generating module 220 so that the grid-side converting circuit 160 receives the current I1 and supply power to the grid 300 according to the current I1. In some other embodiments, the power generating system may include three or more than three power generating modules 220, 240 and a corresponding number of the generator-side converting circuits 120, 140 so that the grid-side converting circuit 160 receives currents output from the various generator-side converting circuits 120, 140 and supplies power to the grid 300.

In some embodiments, the controlling and driving circuit 180 is electrically coupled to the grid-side converting circuit 160 and configured to output a driving signal DS to the grid-side converting circuit 160 so as to control a voltage level Vbus at the node N1 through the grid-side converting circuit 160. In greater detail, in some embodiments, the controlling and driving circuit 180 controls a voltage at the node N1 to be within a medium voltage (MV) level (such as 1 kV-35 kV) through the grid-side converting circuit 160.

For example, in some embodiments, the grid-side converting circuit 160 may include an inverter circuit implemented by a plurality of insulated gate bipolar transistors (IGBT) and control turning on and turning off of a semiconductor switching element through the driving signal DS output by the controlling and driving circuit 180 so as to realize bidirectional energy flow between the node N1 and the grid 300. In this manner, the voltage level Vbus at the node N1 can be controlled and the grid-side converting circuit 160 is kept to outputting AC power having the same frequency and phases as the grid 300 (such as the current Io) so as to supply power to the grid 300 through using the driving signal DS to properly turn on and turn off the semiconductor switching element in the grid-side converting circuit 160.

Through interactions between the above circuits, when the power converting module 100 transmits electric power to the grid-side converting circuit 160 from the generator-side converting circuits 120, 140, energy transmission can be executed by way of DC power within the medium voltage level. Therefore, the line loss on transmission lines can be reduced to improve the overall conversion efficiency of the system.

In addition, since the controlling and driving circuit 180 outputs the driving signal DS, the grid-side converting circuit 160 is allowed to control the voltage level Vbus at the node N1 and the frequency and phases of the output current Io fed into the grid 300. The generator-side converting circuits 120, 140 can thus be designed as high frequency circuits so as to further reduce the cost of the generator-side converting circuits 120, 140. Additionally, the high frequency circuit design can also avoid the problems, such as big volume, high copper loss, high iron loss, etc. caused by a power frequency transformer, thus making the power converting module 100 smaller and more energy efficient.

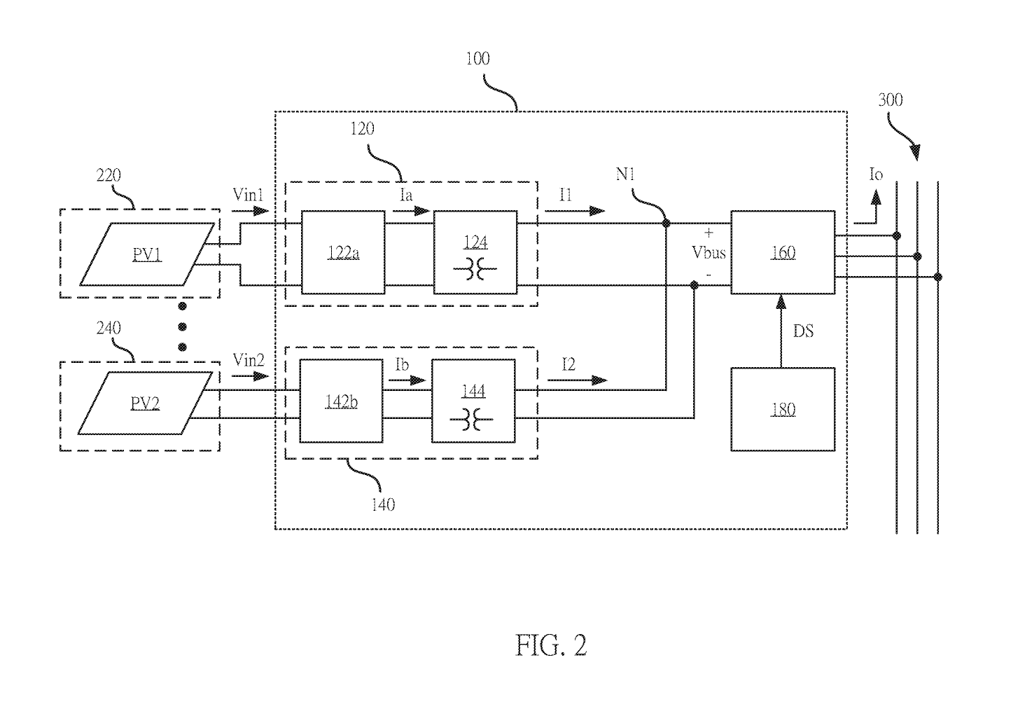

FIG. 2 depicts a schematic diagram of a power generating system according to some embodiments of the present disclosure. The same reference numbers are used in FIG. 2 to refer to the same or like parts relevant to the embodiment shown in FIG. 1 for better understanding, and the detailed principles of the same or like parts are described in the previous paragraphs. A description in this regard is not provided unless the same or like parts have a cooperative relationship with the elements)shown in FIG. 2 and an introduction is thus necessary.

As shown in FIG. 2, in some embodiments, the power generating modules 220, 240 respectively include solar modules PV1, PV2, input voltages Vin1, Vin2 of the generator-side converting circuits 120, 140 are solar photovoltaic DC voltages. The generator-side converting circuits 120, 140 are respectively configured to control the solar modules PV1, PV2 to operate at a maximum power point so as to receive the input voltages Vin1, Vin2 from the power generating modules 220, 240. In greater detail, when the solar modules PV1, PV2 operate at different working points, characteristics of voltages and currents output by them are different from each other. Hence, when the generator-side converting circuits 120, 140 control the solar modules PV1, PV2 to operate at the maximum power point, the power generating modules 220, 240 are allowed to provide a maximum real-time power generating efficiency. In addition to that, as shown in FIG. 2, since the power converting module 100 is a string DC/AC converter according to the present embodiment, the working points of the different power generating modules 220, 240 can be respectively controlled by the generator-side converting circuits 120, 140 corresponding to the power generating modules 220, 240. In this manner, even if the different solar modules PV1, PV2 have different maximum power points when being affected by a phenomenon, such as the shielding effect, each of the generator-side converting circuits 120, 140 still can perform controlling through its respective controller to allow each of the power generating modules 220, 240 to provide the maximum real-time power generating efficiency so as to achieve maximum power point tracking.

In greater detail, the generator-side converting circuit 120 includes DC/DC converting units 122a, 124 according to the embodiment shown in FIG. 2. As for the structure, the DC/DC converting unit 122a is electrically coupled to the solar module PV1, and is configured to control the solar module PV1 to operate at the maximum power point through a control signal output from a controller correspondingly and output a DC current Ia according to the input voltage Vin1. In other words, the DC/DC converting unit 122a can serve as a DC current source to transmit electrical energy output from the solar module PV1 to the DC/DC converting unit 124. In greater detail, in some embodiments, the DC/DC converting unit 122a may be implemented by various converting circuits, such as a boost converter, a buck-boost converter, etc. The generator-side converting circuit 120 outputs the control signal through the corresponding controller to control turning on and turning off of a switching element in the DC/DC converting unit 122a so that the solar module PV1 operates at the maximum power point correspondingly.

The DC/DC converting unit 124 is electrically coupled between the DC/DC converting unit 122a and the node N1 and is configured to output a current I1 to the node N1 according to the DC current Ia. As shown in FIG. 2, in some embodiments, the DC/DC converting unit 124 includes an isolated DC/DC converter configured to provide current isolation between the power generating module 220 and the grid-side converting circuit 160. Hence, it is ensured that each of circuits on two sides of the DC/DC converting unit 124 having different voltage levels operate normally. For example, in some embodiments, a working voltage of the generator-side converting circuit 120 may be 650V or 800V, etc. Conversely, the voltage level Vbus at the node N1 may be within the medium voltage (MV) level that is 1 kV to 35 kV. For example, in some embodiments, the DC/DC converting unit 124 includes a DC transformer (DCX) to realize power isolation and voltage transformation between the forestage and backstage. In greater detail, the DC transformer may be implemented by using an LLC resonant power converter structure. However, the present disclosure is not limited in this regard.

Similarly, in some embodiments, the generator-side converting circuit 140 includes DC/DC converting units 142b, 144. The DC/DC converting unit 142b is electrically coupled to the solar module PV2, and is configured to control the solar module PV2 to operate at the maximum power point and output a DC current Ib according to the input voltage Vin2. The DC/DC converting unit 144 is electrically coupled between the DC/DC converting unit 142b and the node N1 and is configured to output the current I2 to the node N1 according to the DC current Ib. As shown in FIG. 2, in some embodiments, the DC/DC converting unit 144 includes an isolated DC/DC converter configured to provide current isolation between the solar module PV2 and the grid-side converting circuit 160. Since the detailed circuit and operations of the generator-side converting circuit 140 are similar to those of the generator-side converting circuit 120 and are described in detail in the previous paragraphs, a description in this regard is not provided.

It is noted that the DC/DC converting units 122b, 124 and the DC/DC converting units 142b, 144 according to the embodiment shown in FIG. 2 may adopt a variety of suitable power electronic elements (such as an insulated gate bipolar transistor, etc.), and may be implemented by using different types of non-isolated switching power supply circuits or isolated switching power supply circuits.

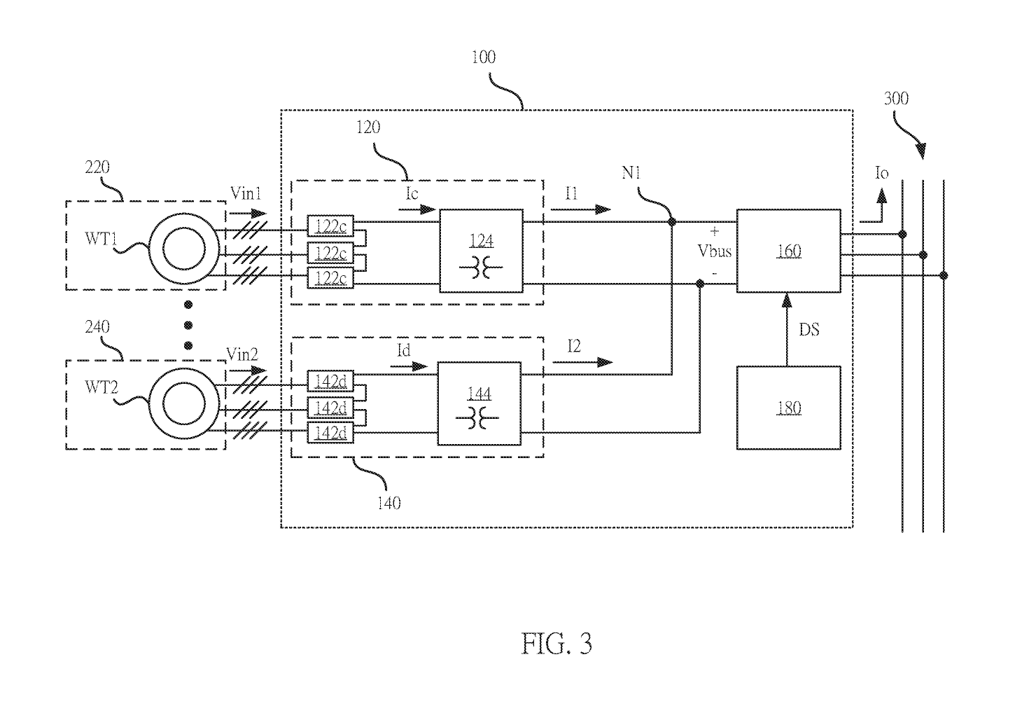

It is noted that the power generating system and the power converting module 100 according to the present disclosure can not only apply to a solar power generating system but also to a wind power system. A description is provided with reference to FIG. 3. FIG. 3 depicts a schematic diagram of a power generating system according to some embodiments of the present disclosure. The same reference numbers are used in FIG. 3 to refer to the same or like parts relevant to the embodiments shown in FIG. 1 and FIG. 2 for better understanding, and the detailed principles of the same or like parts are described in the previous paragraphs. A description in this regard is not provided unless the same or like parts have a cooperative relationship with the element(s) shown in FIG. 3 and an introduction is thus necessary.

As shown in FIG. 3, in some embodiments, the power generating modules 220, 240 respectively include wind turbine generators WT1, WT2, input voltages Vin1, Vin2 of the generator-side converting circuits 120, 140 are AC voltages output from the wind turbine generators WT1, WT2. For example, the wind turbine generators WT1, WT2 can respectively output three-phase AC power to the generator-side converting circuits 120, 140. The generator-side converting circuits 120, 140 are respectively configured to control the wind turbine generators WT1, WT2 to operate at a maximum power point so as to receive the input voltages Vin1, Vin2 from the power generating modules 220, 240.

Similar to the solar power generating system shown in FIG. 2, when the wind turbine generators WT1, WT2 operate at different working points, characteristics of voltages and currents output by them are different from each other. Hence, when the generator-side converting circuits 120, 140 control the wind turbine generators WT1, WT2 to operate at the maximum power point, the power generating modules 220, 240 are allowed to provide a maximum real-time power generating efficiency. In addition to that, as shown in FIG. 3, since the power converting module 100 is a string converter according to the present embodiment, the working points of the different power generating modules 220, 240 can be respectively controlled by the generator-side converting circuits 120, 140 corresponding to the power generating modules 220, 240. In this manner, even if the different wind turbine generators WT1, WT2 have different maximum power points under different wind speeds, each of the generator-side converting circuits 120, 140 still can perform controlling to allow each of the power generating modules 220, 240 to provide the maximum real-time power generating efficiency so as to achieve maximum power point tracking.

As compared with the embodiment shown in FIG. 2, the generator-side converting circuit 120 includes a plurality of AC/DC converting units 122c and the DC/DC converting unit 124 according to the embodiment shown in FIG. 3. As for the structure, the AC/DC converting units 122c are electrically coupled to various windings in the power generating module 220 respectively, and are configured to control the wind turbine generator WT1 to operate at the maximum power point and output a DC current Ic according to the input voltage Vin1. In other words, the DC/DC converting units 122c can serve as DC current sources to transmit electrical energy output from the wind turbine generator WT1 to the DC/DC converting unit 124.

The DC/DC converting unit 124 is electrically coupled between the AC/DC converting units 122c and the node N1 and is configured to output a current I1 to the node N1 according to the DC current Ic. Similar to the embodiment shown in FIG. 2, the DC/DC converting unit 124 may also include an isolated DC/DC converter configured to provide current isolation between the power generating module 220 and the grid-side converting circuit 160 according to the present embodiment. Hence, it is ensured that each of circuits on two sides of the DC/DC converting unit 124 having different voltage levels operate normally.

Similarly, in some embodiments, the generator-side converting circuit 140 includes a plurality of AC/DC converting units 142d and the DC/DC converting unit 144. The AC/DC converting units 142d are electrically coupled to various windings in the power generating module 240 respectively, and are configured to control the wind turbine generator WT2 to operate at the maximum power point and output a DC current Id according to the input voltage Vin2. The DC/DC converting unit 144 is electrically coupled between the AC/DC converting units 142d and the node N1 and is configured to output a current I2 to the node N1 according to the DC current Id. Since the detailed circuit and operations of the generator-side converting circuit 140 are similar to those of the generator-side converting circuit 120 and are described in detail in the previous paragraphs, a description in this regard is not provided.

In other words, a shown in FIG. 2 and FIG. 3, the power converting module 100 may include the generator-side converting circuits 120, 140 correspondingly to cooperate with the different power generating modules 220, 240, such as the solar modules PV1, PV2 of the solar power generating system or the wind turbine generators WT1, WT2 of the wind power system according to different embodiments of the present disclosure. Hence, the power converting module 100 can be applied to different renewable energy power generating systems to reduce the volume and cost of the power converting module 100. In addition to that, the maximum power point tracking on a generator side can also be achieved and the copper loss and iron loss can also be reduced through the high frequency circuits of the power converting module 100 and controls of the power converting module 100 correspondingly. As a result, the overall generating efficiency and conversion efficiency of the system can be increased.

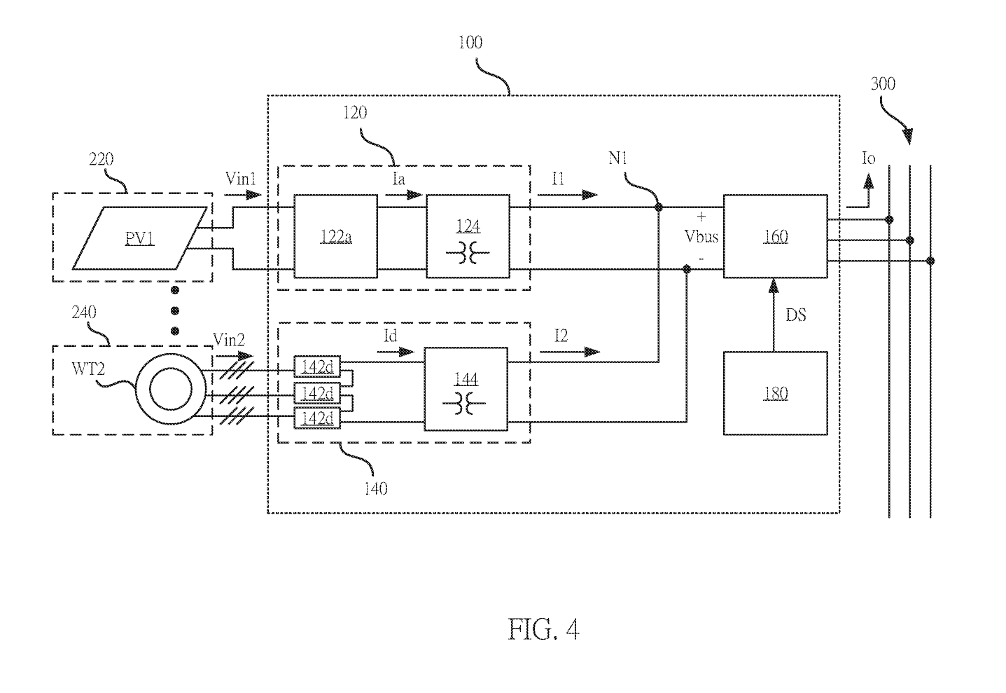

In addition, in some embodiments, the power converting module 100 may also be applied to a solar-wind hybrid power generating system. A description is provided with reference to FIG. 4. FIG. 4 depicts a schematic diagram of a power generating system according to some embodiments of the present disclosure. The same reference numbers are used in FIG. 4 to refer to the same or like parts relevant to the embodiments shown in FIG. 1 to FIG. 3 for better understanding, and the detailed principles of the same or like parts are described in the previous paragraphs. A description in this regard is not provided unless the same or like parts have a cooperative relationship with the element(s) shown in FIG. 4 and an introduction is thus necessary.

As shown in FIG. 4, the generator-side converting circuits 120, 140 in the power converting module 100 can respectively receive input voltages Vin1, Vin2 from a solar module PV1 and a wind turbine generator WT2, and respectively output DC currents Ia, Id to the DC/DC converting units 124, 144 through the DC/DC converting unit 122a and the AC/DC converting units 142d. In this manner, the grid-side converting circuit 160 can receive electrical energy from the generator-side converting circuits 120, 140 connected to different renewable energy power generating equipment and convert the electrical energy into a current form suitable for being output to the grid 300. Therefore, the power converting module 100 can be applied to the solar-wind hybrid power generating system to operate. Additionally, although only the one solar module PV1 and the one wind turbine generator WT2 are depicted in the embodiment shown in FIG. 4, they only serve as an example and are not intended to limit the present disclosure. As mentioned previously, those of ordinary skill in the art may dispose the number and types of the generator-side converting circuits 120, 140 depending on practical needs to match the number and types of the power generating modules 220, 240 in the power generating system, so that the grid-side converting circuit 160 receives the current I1, I2 output from the various generator-side converting circuits 120, 140 and supplies power to the grid 300 accordingly,

In addition, similarly, the generator-side converting circuits 120, 140 in the power converting module 100 can also respectively receive the input voltages from other different power sources, and electrical energy are received through the corresponding generator-side converting circuits 120, 140, and the electrical energy are converted into a current form suitable for being output to the grid 300. In other words, the power converting module 100 may also be applied to a variety of hybrid power generating systems to operate. For example, the power converting module 100 may receive electric power from power generating equipment using different renewable energies or conventional energies, such as hydroelectric power generation, tidal power generation, ocean current power generation, thermal power generation, nuclear power generation, and the like, and convert electrical energy into a form of a suitable current source through the generator-side converting circuits 120, 140, and supply the electric power generated by the various types of equipment to the grid-side converting circuit 160 though connecting circuits in parallel. In addition, the grid-side converting circuit 160 controls a voltage level Vbus at the node N1 and a frequency and phases of and an output current Io fed into the grid 300 so as to supply power to the grid 300.

Similar to the converting circuits in the embodiment shown in FIG. 2, the AC/DC converting circuits 122c, 142d according to the embodiments shown in FIG. 3 and FIG. 4 may adopt a variety of suitable power electronic elements (such as an insulated gate bipolar transistor,etc.), and may be implemented by using different types of non-isolated switching power supply circuits.

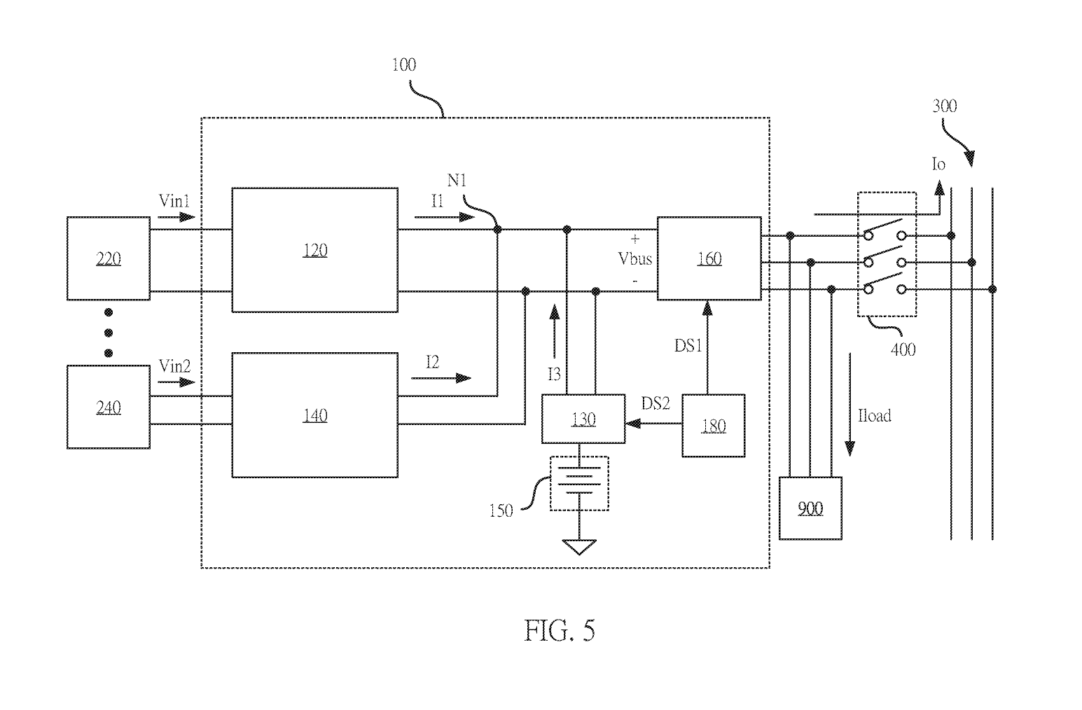

A description is provided with reference to FIG. 5. FIG. 5 depicts a schematic diagram of a power generating system according to some other embodiments of the present disclosure. The same reference numbers are used in FIG. 5 to refer to the same or like parts relevant to the embodiment shown in FIG. 1 for better understanding, and the detailed principles of the same or like parts are described in the previous paragraphs. A description in this regard is not provided unless the same or like parts have a cooperative relationship with the element(s) shown in FIG. 5 and an introduction is thus necessary.

As compared with the embodiment shown in FIG. 1, in some embodiments, a power generating system further includes a grid-side switching circuit 400 and a local load 900 as shown in FIG. 5. The grid-side switching circuit 400 is disposed between the power converting module 100 and the grid 300. In greater detail, as shown in the figure, the grid-side switching circuit 400 is electrically coupled between the grid-side converting circuit 160 in the power converting module 100 and the grid 300 according to some embodiments. When the power converting module 100 and the grid 300 operate in a grid-connected mode, the power converting module 100 outputs a current Io to supply power to the grid 300 through the turned-on grid-side switching circuit 400. Conversely, when the grid 300 is abnormal, the grid-side switching circuit 400 is selectively turned off correspondingly so as to isolate the grid-side converting circuit 160 and the grid 300.

In this manner, when the grid 300 is powered down or when an abnormal power quality occurs, the grid-side switching circuit 400 can be turned off through a control strategy correspondingly so as to protect equipment in the power converting module 100 and the power generating modules 220, 240. Similarly, the system can also control the grid-side switching circuit 400 to turn off when detecting that the power converting module 100 and the power generating modules 220, 240 are abnormal. The power converting module 100 and the power generating modules 220, 240 are thus separated from the commercial power to ensure that a system of the grid 300 is stable. In this manner, through disposing the grid-side switching circuit 400 that automatically trips when a malfunction or an abnormal state is detected, damage to equipment can be avoided or further deterioration of grid stability can be avoided.

Additionally, in some embodiments, the grid-side converting circuit 160 is further configured to be electrically coupled to the local load 900 so as to supply power to the local load 900. As a result, even if the power converting module 100 and the power generating modules 220, 240 are not connected to the grid 300, an islanded mode can be operated to directly supply a load current Iload to the local load 900 so as to provide electric power required by the local load 900. It is noted that, in some embodiments, some other functional circuit(s) may be disposed in the power converting module 100 to ensure that the power converting module 100 and the power generating modules 220, 240 provide the stable load current Iload to the local load when they operate in the islanded mode.

As shown in FIG. 5, in some embodiments, the power converting module 100 further includes a storage-side converting circuit 130 and an energy storage device 150. In greater detail, the storage-side converting circuit 130 may includes a DC/DC converting circuit. The energy storage device 150 may include a power storage device, such as a battery As for the structure, the storage-side converting circuit 130 is electrically coupled between the node N1 and the energy storage device 150. As a result, the storage-side converting circuit 130 can provide the node N1 with an energy storage current I3 or receive the energy storage current I3 from the node N1 to charge or discharge the energy storage device 150 so as to maintain the stability of the voltage level Vbus at the node N1.

In other words, the storage-side converting circuit 130 may realize bidirectional electric power transmission between the node N1 and energy storage device 150 to cooperate with operations of the grid-side converting circuit 160 so as to maintain the power balance of the system. The storage-side converting circuit 130 can perform control through the controlling and driving circuit 180. In greater detail, in the present embodiment, not only can the controlling and driving circuit 180 output a driving signal DS1 to the grid-side converting circuit 160 to control the operations of the grid-side converting circuit 160, but the controlling and driving circuit 180 can also output a driving signal DS2 to the storage-side converting circuit 130 to control the energy storage current I3 through the storage-side converting circuit 130. A magnitude of the energy storage current I3 output to the storage-side converting circuit 130 from the node N1 is adjusted accordingly, or the magnitude of the energy storage current I3 output to the node N1 from the storage-side converting circuit 130 is adjusted accordingly.

For example, under favorable conditions, such as abundant sunshine, abundant wind power, etc., power generated on a generator side is more than electric power allocated by the grid 300 and electric power required by the local load 900. Extra electric power transmitted from the power generating modules 220, 240 can be transmitted from the node N1 to the energy storage device 150 through the storage-side converting circuit 130 in a form of the energy storage current I3 and stored in the energy storage device 150 so as to avoid accumulation of energy in the circuit because of excessive power generation that results in dramatic changes of the voltage level Vbus at the node N1.

On the contrary, under unfavorable conditions, such as light shading, abatement of wind, etc., the power generated on the generator side is not sufficient for supplying the electric power allocated by the grid 300 and the electric power required by the local load 900. The grid-side converting circuit 160 can receive the energy storage current I3 from the storage-side converting circuit 130 through the node N1 to avoid the dramatic changes of the voltage level Vbus at the node N1 caused by insufficient power generation. In this manner, the electric power stored in the energy storage device 150 can be output through the storage-side converting circuit 130 and converted into AC power having a suitable frequency and suitable phases through the grid-side converting circuit 160 and transmitted to a load side, such as the grid 300 and the local load 900, etc.

Therefore, when the power generating modules 220, 240, the power converting module 100, and the grid 300 operate in a grid-connected mode, power received by the grid 300 from the grid-side converting circuit 160 can be relatively stable to avoid dramatic changes of power caused by changes of power generation amount of the power generating modules 220, 240, which in turn deteriorates a power quality of the grid 300. Additionally, when the power generating modules 220, 240 and the power converting module 100 operate in the islanded mode and are not connected to the grid 300, the power converting module 100 can also realize load balance in the circuit by using the energy storage device 150. Extra electric power is stored in the energy storage device 150 when the power generation amount of the power generating modules 220, 240 is more than power consumption amount of the local load 900, and the energy stored in the energy storage device 150 is used to replenish the insufficient power generation when the power generation amount of the power generating modules 220, 240 is less than the power consumption amount of the local load 900 so as to maintain a stable power supply quality.

It is noted that the storage-side converting circuit 130 according to the embodiment shown in FIG. 5 may adopt a variety of suitable power electronic elements (such as an insulated gate bipolar transistor, etc.), and may be implemented by using different types of switching power supply circuits. In addition to that, the grid-side switching circuit 400 may be implemented by using different types of power electronic elements.

In summary, according to the previous embodiments, the grid-side converting circuit 160 can realize bidirectional transmission of electric power between the node N1 and the load side (such as the grid 300 or the local load 900) through control of the controlling and driving circuit 180, and control the voltage level Vbus at the node N1 accordingly. In addition, in some embodiments, the storage-side converting circuit 130 can realize bidirectional transmission of electric power between the node N1 and the energy storage device 150 through the control of the controlling and driving circuit 180. Hence, through the proper control of the controlling and driving circuit 180, energy balance can be achieved between the currents I1, I2 output by the generator-side converting circuits 120, 140 together with the energy storage current I3 output from or received by the storage-side converting circuit 130 and the current Io and/or the load current Iload received by the load side.

At the same time, since the generator-side converting circuits 120, 140 do not need to control the voltage level Vbus at the node N1, high frequency circuits can be adopted. Hence, the volume and cost are reduced. Additionally, losses such as copper loss, iron loss, etc. in the circuits and in the converting circuits can also be effectively reduced. As a result, the system can have a higher energy conversion efficiency no matter whether at full load or no load.

Additionally, it is noted that, unless there is any conflict, the various drawings, embodiments, and features and circuits in the embodiments according to the present disclosure may be combined with one another. The circuits shown in the above figures are for illustrative purposes only and are simplified to make the description concise and understandable and are not intended to limit the present disclosure.

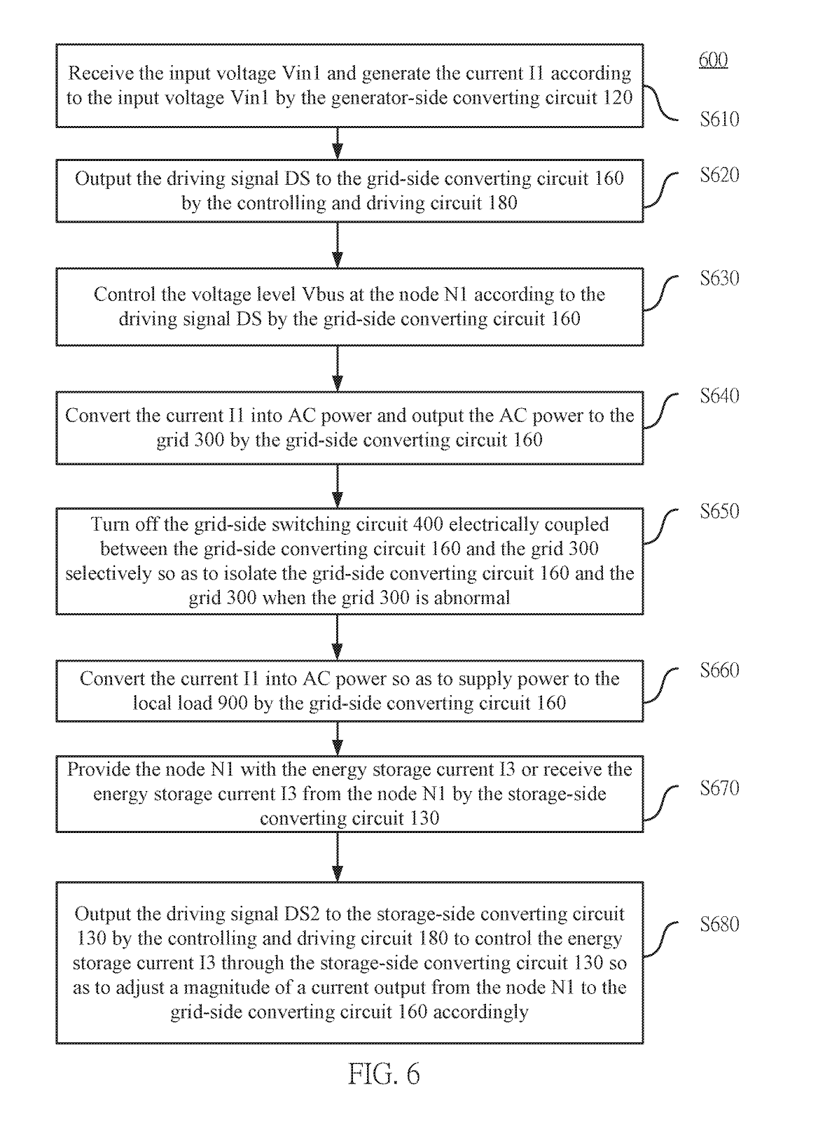

A description is provided with reference to FIG. 6. FIG. 6 depicts a flowchart of a control method 600 of a power generating system according to some embodiments of the present disclosure. For the sake of convenience and clarity, the control method 600 is described with reference to the embodiments shown in FIG. 1 to FIG. 5, but the control method 600 is not limited in this regard. It will be apparent to those skilled in the art that various changes and modifications may be made therein without departing from the spirit and scope of the present disclosure. As shown in FIG. 6, the control method 600 includes steps S610, S620, S630, and S640. In some embodiments, the control method 600 may further include steps S650 and S660. In some embodiments, the control method 600 may further include steps S670 and S680.

First, in step S610, the generator-side converting circuit 120 receives the input voltage Vin1 and generates the current I1 according to the input voltage Vin1. In various embodiments, the input voltage Vin1 may be in a form of direct current or alternating current depending on sources of the electric power. In greater detail, in some embodiments, step S610 may include controlling the solar module PV1 to operate at the maximum power point so as to receive the input voltage Vin1 that is a DC voltage from the solar module PV1. For example, in step S610, the DC/DC converting unit 122a in the generator-side converting circuit 120 may control the solar module PV1 to operate at the maximum power point. Then, the DC/DC converting unit 122a outputs the DC current Ia according to the input voltage Vin1. Finally, the DC/DC converting unit 124 in the generator-side converting circuit 120 outputs the current I1 to the node N1 according to the DC current Ia.

In addition, in some other embodiments, step S610 may include controlling the wind turbine generator WT1 to operate at the maximum power point so as to receive the input voltage Vin1 that is an AC voltage from the wind turbine generator WT1. For example, in step S610, the AC/DC converting units 122c in the generator-side converting circuit 120 can control the wind turbine generator WT1 to operate at the maximum power point. Then, the AC/DC converting units 122c output the DC current Ic according to the input voltage Vin1. Finally, the DC/DC converting unit 124 in the generator-side converting circuit 120 outputs the current I1 to the node N1 according to the DC current Ic.

After that, in step S620, the controlling and driving circuit 180 outputs the driving signal DS to the grid-side converting circuit 160. As mentioned in the previous paragraphs, in some embodiments, the grid-side converting circuit 160 is coupled to the generator-side converting circuit 120 at the node N1.

Then, in step S630, the voltage level Vbus at the node N1 is controlled according to the driving signal DS through the grid-side converting circuit 160. In greater detail, the grid-side converting circuit 160 can control the voltage level Vbus at the node N1 to be within the medium voltage (MV) level. As a result, line loss can be reduced.

Finally, in step S640, the grid-side converting circuit 160 converts the current I1 into AC power and outputs the AC power to the grid 300. For example, in some embodiments, step S640 may include outputting the AC power having a same frequency and same phases as the grid 300 by the DC/AC converting unit in the grid-side converting circuit 160 to supply power to the grid 300.

In addition to that, in some embodiments, the control method 600 may also include receiving the input voltage Vin2 and outputting the current I2 according to the input voltage Vin2 by the generator-side converting circuit 140, and receiving the current I1 and the current I2 from the node N1 and converting the current I1 and the current I2 into AC power by the grid-side converting circuit 160 and outputting the AC power to the grid 300. Since the detailed operations have been provided in the previous paragraphs with reference to the plurality of embodiments, a description in this regard is not provided.

In some embodiments, the control method 600 further includes step S650 and step S660 to control the power generating system to operate in the islanded mode. For example, in step S650, the grid-side switching circuit 400 electrically coupled between the grid-side converting circuit 160 and the grid 300 is selectively turned off when the grid 300 is abnormal to isolate the grid-side converting circuit 160 and the grid 300. Then, in step S660, the grid-side converting circuit 160 converts the current I1 into AC power so as to supply power to the local load 900. Hence, even if the grid 300 is disconnected, the power generating system still can supply power to the local load 900 under the islanded mode.

In some embodiments, the control method 600 further includes step S670 and step S680 to cooperate with the energy storage device 150. For example, in step S670, the storage-side converting circuit 130 provides the node N1 with the energy storage current I3 or receives the energy storage current I3 from the node N1. In step S680, the controlling and driving circuit 180 outputs the driving signal DS2 to the storage-side converting circuit 130 to control the energy storage current I3 through the storage-side converting circuit 130. A magnitude of a current output from the node N1 to the grid-side converting circuit 160 is thus adjusted accordingly. As a result, the power generating system can maintain its balance between supply and demand through charging and discharging the energy storage device 150 by using the energy storage current I3.

Since those of ordinary skill in the art would understand how the control method 600 performs operations and functions based on the power generating systems according to the previous various embodiments, a description in this regard is not provided.

In addition, while the method according to the present disclosure is illustrated and described below as a series of steps or events, it will be appreciated that the illustrated ordering of such steps or events are not to be interpreted in a limiting sense. For example, some steps may occur in different orders and/or concurrently with other steps or events apart from those illustrated and/or described herein. Additionally, not all illustrated steps may be required to implement one or more aspects or embodiments described herein. Also, one or more of the steps disclosed herein may be carried out in one or more separate steps and/or phases.

In summary, according to the embodiments of the present disclosure, the DC power within the medium voltage (MV) level is used to transmit energy in the converting module. Therefore, the line loss on transmission lines can be reduced to improve the overall conversion efficiency of the system. In addition to that, because the present disclosure converting module controls the voltage level at the node and the frequency and phases of the output current fed into the grid through the grid-side converting circuit by using the driving signal output by the driving circuit, the generator-side converting circuits can adopt high frequency circuits. Hence, the cost of the generator-side converting circuits is reduced. The volume of the generator-side converting circuits is decreased. The copper loss and iron loss are also reduced. As a result, the converting module becomes smaller and more energy efficient.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A power converting module comprising:
a first generator-side converting circuit configured to receive an input voltage and output a first current according to the input voltage;
a grid-side converting circuit electrically coupled to the first generator-side converting circuit at a node, and configured to receive the first current and supply power to a grid according to the first current; and
a controlling and driving circuit configured to output a driving signal to the grid-side converting circuit to control a voltage level at the node through the grid-side converting circuit, wherein a voltage at the node is within a medium voltage level.

2. The power converting module of claim 1, wherein the first generator-side converting circuit is configured to control a solar module to operate at a maximum power point so as to receive the input voltage from the solar module, wherein the input voltage is a DC voltage.

3. The power converting module of claim 2, wherein the first generator-side converting circuit comprises:
a first DC/DC converting unit configured to control the solar module to operate at the maximum power point, and output a DC current according to the input voltage; and
a second DC/DC converting unit electrically connected between the first DC/DC converting unit and the node, and configured to output the first current to the node according to the DC current.

4. The power converting module of claim 3, wherein the second DC/DC converting unit comprises an isolated DC/DC converter configured to provide current isolation between the solar module and the grid-side converting circuit.

5. The power converting module of claim 1, wherein the first generator-side converting circuit is configured to control a wind turbine generator to operate at a maximum power point so as to receive the input voltage from the wind turbine generator, wherein the input voltage is an AC voltage.

6. The power converting module of claim 5, wherein the first generator-side converting circuit comprises:
an AC/DC converting unit configured to control the wind turbine generator to operate at the maximum power point, and output a DC current according to the input voltage; and
a DC/DC converting unit electrically connected between the AC/DC converting unit and the node, and configured to output the first current to the node according to the DC current.

7. The power converting module of claim 1, wherein the grid-side converting circuit comprises a DC/AC converting unit, the DC/AC converting unit is configure to output AC power having a same frequency and same phases as the grid so as to supply power to the grid.

8. The power converting module of claim 1, further comprising:
a second generator-side converting circuit configured to receive a second input voltage and output a second current according to the second input voltage;
wherein the grid-side converting circuit is electrically coupled to the second generator-side converting circuit at the node, and configured to receive the second current and supply power to the grid according to the first current and the second current.

9. The power converting module of claim 1, further comprising:
an energy storage device; and
a storage-side converting circuit electrically coupled between the node and the energy storage device, and configured to provide the node with an energy storage current or receive the energy storage current from the node so as to charge or discharge the energy storage device;
wherein the controlling and driving circuit is further configured to output a second driving signal to the storage-side converting circuit to control the energy storage current through the storage-side converting circuit so as to adjust a magnitude of a current output from the node to the grid-side converting circuit accordingly.

10. A power generating system comprising:
a power generating module;
a power converting module comprising:
a first generator-side converting circuit electrically coupled to the power generating module, and configured to receive an input voltage from the power generating module and output a first current according to the input voltage;
a grid-side converting circuit electrically coupled to the first generator-side converting circuit at a node, and configured to receive the first current and supply power to a grid according to the first current; and
a controlling and driving circuit configured to output a driving signal to the grid-side converting circuit to control a voltage level at the node through the grid-side converting circuit; and
a grid-side switching circuit electrically coupled between the grid-side converting circuit and the grid, and configured to be selectively turned off so as to isolate the grid-side converting circuit and the grid when the grid is abnormal.

11. The power generating system of claim 10, wherein the grid-side converting circuit is further configured to be electrically coupled to a local load so as to supply power to the local load.

12. A control method of a power generating system comprising:
receiving an input voltage and generating a first current according to the input voltage by a first generator-side converting circuit;
outputting a driving signal to a grid-side converting circuit by a controlling and driving circuit, wherein the grid-side converting circuit is coupled to the first generator-side converting circuit at a node;
controlling a voltage level at the node according to the driving signal by the grid-side converting circuit; and
converting the first current into AC power and outputting the AC power to a grid by the grid-side converting circuit.

13. The control method of claim 12, wherein the step of generating the first current through the first generator-side converting circuit comprises:
controlling a solar module to operate at a maximum power point so as to receive the input voltage from the solar module, wherein the input voltage is a DC voltage.

14. The control method of claim 13, wherein the step of generating the first current through the first generator-side converting circuit further comprises:
controlling the solar module to operate at the maximum power point by a first DC/DC converting unit in the first generator-side converting circuit;
outputting a DC current according to the input voltage by the first DC/DC converting unit; and
outputting the first current to the node according to the DC current by a second DC/DC converting unit in the first generator-side converting circuit.

15. The control method of claim 12, wherein the step of generating the first current through the first generator-side converting circuit comprises:
controlling a wind turbine generator to operate at a maximum power point so as to receive the input voltage from the wind turbine generator, wherein the input voltage is an AC voltage.

16. The control method of claim 15, wherein the step of generating the first current through the first generator-side converting circuit further comprises:
controlling the wind turbine generator to operate at the maximum power point by an AC/DC converting unit in the first generator-side converting circuit;
outputting a DC current according to the input voltage by the AC/DC converting unit; and
outputting the first current to the node according to the DC current by a DC/DC converting unit in the first generator-side converting circuit.

17. The control method of claim 12, wherein the step of converting the first current into the AC power and outputting the AC power to the grid by the grid-side converting circuit comprises:
outputting the AC power having a same frequency and same phases as the grid by a DC/AC converting unit in the grid-side converting circuit so as to supply power to the grid.

18. The control method of claim 12, further comprising:
receiving a second input voltage and outputting a second current according to the second input voltage by a second generator-side converting circuit; and
receiving the first current and the second current from the node and converting the first current and the second current into AC power by the grid-side converting circuit and outputting the AC power to the grid.

19. The control method of claim 12, further comprising:
turning off a grid-side switching circuit electrically coupled between the grid-side converting circuit and the grid selectively so as to isolate the grid-side converting circuit and the grid when the grid is abnormal; and
converting the first current into AC power so as to supply power to a local load by the grid-side converting circuit.

20. The control method of claim 12, further comprising:
providing the node with an energy storage current or receiving the energy storage current from the node by a storage-side converting circuit; and
outputting a second driving signal to the storage-side converting circuit by the controlling and driving circuit to control the energy storage current through the storage-side converting circuit so as to adjust a magnitude of a current output from the node to the grid-side converting circuit accordingly.
